(19) United States
(12) Patent Application Publication
(10) Pub. No.: US 2017/0132476 A1
(43) Pub. Date: May 11, 2017

(54) Vehicle Imaging System

(71) Applicant: OTOBRITE ELECTRONICS INC., Hsinchu (TW)

(72) Inventors: Chung-Fang Chien, Taipei (TW); Ta Hsien, Taichung (TW)

(21) Appl. No.: 14/935,437

(22) Filed: Nov. 8, 2015

(51) Int. Cl. G06K 9/00; B60R 1/00; H04N 5/247; G06T 11/60; G06T 5/50

(52) U.S. Cl. CPC G06K 9/00791; G06T 11/60; G06T 5/50; H04N 5/247; B60R 1/00; G06T 2207/30252; G06T 2207/10016; B60R 2300/105; B60R 2300/202

(57) ABSTRACT

An automotive imaging system may include image sensors that capture images from a vehicle's surroundings. The vehicle's chassis may partially obstruct the environment from the view of the image sensors. The imaging system may include processing circuitry that receives image frames from the image sensors and process the image frames to generate image data portraying blocked portions of the vehicle's surrounding environment. The processing circuitry may generate the image data during movement of the vehicle by combining time-delayed image data from the sensors with current image data from the sensors.

### BACKGROUND

This relates to imaging systems, and, in particular, to imaging systems for automotive vehicles. Vehicles such as cars, trucks, other motor-driven vehicles are sometimes provided with one or more cameras that capture images or video of the surrounding environment. For example, a rear-view camera can be mounted at the rear of an automobile and used to capture video of the environment at the rear of the automobile. While the automobile is in a reverse-driving mode, the captured video can be displayed (e.g., at a center console display) for the driver or passengers. Such imaging systems can help assist the driver or passengers in operating the vehicle, and can function to help improve vehicle safety. For example, displayed video image data from a rear-view camera can help a user to identify path obstructions that would otherwise be difficult to visually identify (e.g., through the rear windshield, rear-view mirrors, or side mirrors of the vehicle).

Vehicles are sometimes also provided with additional cameras mounted to the vehicles at various positions. For example, cameras may be mounted to the front, sides, and rear of the vehicles. The cameras capture various regions of the surrounding environment. However, each addition of a camera can be costly, and it can be impractical or cost-prohibitive to provide each vehicle with a sufficient number of cameras to capture the entirety of vehicle surroundings.

### SUMMARY

An imaging system may include one or more image sensors that capture video data (e.g., successive image data frames in time). The imaging system may be an automotive system in which the image sensors may be used to capture images from a vehicle's surroundings. The image sensor(s) may be mounted to the vehicle at various locations, such as at front and rear opposing sides and left and right opposing sides. For example, the left and right image sensors may be mounted to side view mirrors of the vehicle. The imaging system may include processing circuitry that receives image frames from the image sensors and process the image frames to generate image data portraying blocked portions of the vehicle's surrounding environment. For example, the vehicle's chassis or other parts attached to the vehicle may partially obstruct the environment from the view of one or more of the image sensors. The processing circuitry may generate the image data during movement of the vehicle by combining time-delayed image data from the sensors with current image data from the sensors. The generated image data may sometimes be referred to herein as obstruction-compensated images, because the images have been processed to compensate for obstructions that block the view of the image sensors. If desired, the processing circuitry may perform additional image processing on the captured image data such as coordinate transformation to a common perspective and lens distortion correction.

The processing circuitry may, based on movement of the vehicle, identify portions of the current vehicle surroundings that are blocked and identify previously captured image data that can be used to portray the blocked portions of the vehicle's current surroundings. Vehicle data obtained for the vehicle (e.g., from an onboard vehicle computer) such as vehicle speed, steering angle, gear mode, and wheelbase length may be used by the processing circuitry in identifying movement of the vehicle and determining which portions of previously captured image data should be used in portraying currently blocked portions of the vehicle's surrounding environment.

Further features of the invention, its nature and various advantages will be more apparent from the accompanying drawings and the following detailed description of the preferred embodiments.

### BRIEF DESCRIPTION OF THE DRAWINGS

FIG. 1 is an illustrative diagram of displayed obstruction-compensated images in accordance with an embodiment of the present invention.

FIG. 2 is a diagram illustrating coordinate transformation that may be used to combine images from multiple cameras having different perspective views in accordance with an embodiment of the present invention.

FIG. 3 is an illustrative diagram showing how camera-obstructed regions of a surrounding environment may be updated with time-delayed information based on steering angle and vehicle speed information in accordance with an embodiment of the present invention.

FIG. 4 is an illustrative diagram showing how an image buffer may be updated with current and time-delayed camera image data in displaying an obstruction-compensated image of vehicle surroundings in accordance with an embodiment of the present invention.

FIG. 5 is a flowchart of illustrative steps that may be performed to display an obstruction-compensated image in accordance with an embodiment of the present invention.

FIG. 6 is an illustrative diagram of an automotive vehicle having multiple cameras that capture image data that may be combined to generate obstruction-compensated video image data in accordance with an embodiment of the invention.

FIG. 7 is a block diagram of an illustrative imaging system that may be used to process camera image data to generate obstruction-compensated video image data in accordance with an embodiment of the invention.

FIG. 8 is a diagram illustrating how multiple buffers may be updated in succession to store current and time-delayed camera image data in displaying an obstruction-compensated image of vehicle surroundings in accordance with an embodiment of the present invention.

### DETAILED DESCRIPTION

The present invention relates to imaging systems, and, in particular, to imaging systems that visually compensate for camera obstructions by storing and combining time-delayed image data with current image data. Imaging systems that compensate for camera obstructions are described herein in connection with automotive vehicles. These examples are merely illustrative. In general, obstruction-compensation processes and systems may be implemented for any desired imaging system for displaying environments that are partially obstructed from camera view.

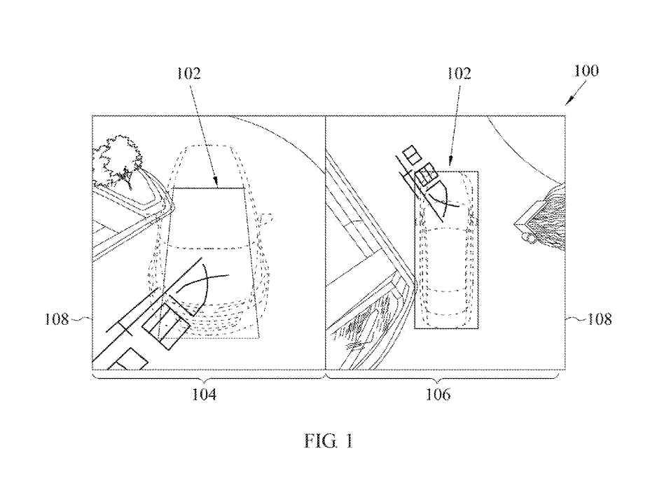

FIG. 1 shows a diagram of an obstruction-compensated image 100 that may be created using time-delayed image data. In the example of FIG. 1, image 100 may be generated from image data such as video image data from multiple cameras mounted to a vehicle at various locations. For example, cameras may be mounted to the front, rear, and/or sides of the vehicle. Image 100 may include portions 104 and 106, each portraying a different perspective of the surrounding environment. Image portion 104 may reflect a front perspective view of the vehicle and its surroundings, whereas image portion 106 may portray a top-down view (sometimes referred to as a birds eye view, because image portion 106 appears to have been captured from a vantage point above the vehicle).

Image portions 104 and 106 may include regions 102 that correspond to portions of the surrounding environment that are obstructed from camera view. In particular, the vehicle may include a frame or chassis that provides structural support for the various components and parts of the vehicle (e.g., support for the motor, wheels, seats, etc.). The cameras may be mounted directly or indirectly to the vehicle chassis, and the chassis itself may obstruct parts of the vehicle surroundings from the cameras. Regions 102 correspond to portions underneath the vehicle chassis that are obstructed from camera view, whereas regions 108 correspond to unobstructed surroundings. In the example of FIG. 1, the vehicle is moving on a road, and regions 102 display portions of the road that are currently underneath the vehicle chassis and would otherwise be obstructed from view of cameras that are mounted to the front, sides, and/or rear of the vehicle. Image data in regions 102 may be generated using time-delayed image data received from the vehicle cameras, whereas image data in regions 108 may be generated using current image data from the vehicle cameras (e.g., because the corresponding portions of the surrounding environment are not obstructed from view of the cameras by the vehicle chassis).

Successive images 100 (e.g., images generated at successive times) may form a stream of images, sometimes referred to as a video stream or video data. The example of FIG. 1 in which image 100 is composed of regions 104 and 106 is merely illustrative. Image 100 may be composed of one or more regions each having a front perspective view (e.g., region 104), a birds eye view (e.g., region 106), or any desired view of the vehicle's surrounding environment that is generated from image data from the cameras.

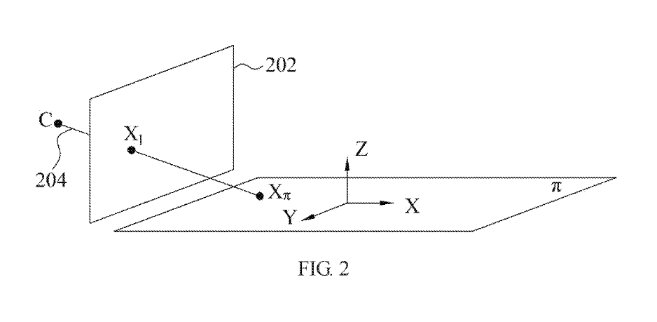

Cameras that are mounted to a vehicle each have a different view of the surrounding environment. It may be desirable to transform the image data from each camera to a common perspective. For example, image data from multiple cameras may each be transformed to the front perspective view of image region 104 and/or the birds eye perspective view of image region 106. FIG. 2 shows how image data from a given camera in a first plane 202 may be transformed to a desired coordinate plane n defined by the orthogonal X, Y, and Z axis. As an example, coordinate plane n may be a ground plane that extends between the wheels of the automotive vehicle. The transformation of image data from one coordinate plane (e.g., the plane as captured by the camera) to another coordinate plane may sometimes be referred to as coordinate transformation, or projective transformation.

As shown in FIG. 2, images captured by the camera may include image data (e.g., a pixel) at coordinates such as point x1 in camera plane 202 along vector 204. Vector 204 extends between point x1 in plane 202 and a corresponding point xn in target plane n. For example, vector 204 may be based on the angle at which the camera is mounted on the car and angled towards the ground, because vector 204 is drawn between a point on plane 202 of the camera and plane n of the ground plane.

Image data captured by the camera in coordinate plane 202 may be transformed (e.g., projected) onto coordinate plane n according to a matrix formula xπ=H*x1. Matrix H can be calculated and determined via calibration processes for the camera. For example, the camera may be mounted to a desired location on a vehicle, and calibration images may be taken to produce images of a known environment. In this scenario, multiple pairs of corresponding points in planes 202 and n may be known (e.g., x1 and xn may constitute a pair), and H can be calculated based on the known points.

As an example, point x1 may be defined as x1=(xᵢ,yᵢ,ωᵢ) by the coordinate system of plane 202, whereas point xπ may be defined as xπ=(xᵢ′,yᵢ′,ωᵢ′) by the coordinate system of plane π. In this scenario, matrix H may be defined as shown in equation 1, the relationship between x1 and xπ may be defined as shown in equation 2.

$$\begin{matrix}H = [ \begin{matrix}{h}_{11} & {h}_{12} & {h}_{13} \\ {h}_{21} & {h}_{22} & {h}_{23} \\ {h}_{31} & {h}_{32} & 1\end{matrix} ] & Equation 1 \\ [ \begin{matrix}{h}_{11} & {h}_{12} & {h}_{13} \\ {h}_{21} & {h}_{22} & {h}_{23} \\ {h}_{31} & {h}_{32} & 1\end{matrix} ] [ \begin{matrix}{x}_{i} \\ {y}_{i} \\ {ω}_{i}\end{matrix} ] = [ \begin{matrix}{x}_{i}^{′} \\ {y}_{i}^{′} \\ {ω}_{i}^{′}\end{matrix} ] & Equation 2\end{matrix}$$

Each camera that is mounted to the vehicle may be calibrated to calculate a respective matrix H that transforms coordinates at the camera's plane to a desired coordinate plane. For example, in a scenario in which cameras are mounted to the front, rear, and sides of a vehicle, each of the cameras may be calibrated to determined respective matrices that transform image data captured by that camera to projected image data on a shared, common image plane (e.g., a ground image plane from a birds eye perspective such as shown in image region 106 of FIG. 1, or the common plane of a front perspective view as shown in image region 104 of FIG. 1). During display operations, the image data from each of the cameras may be transformed using the calculated matrices and combined to display the surrounding environment from the desired perspective.

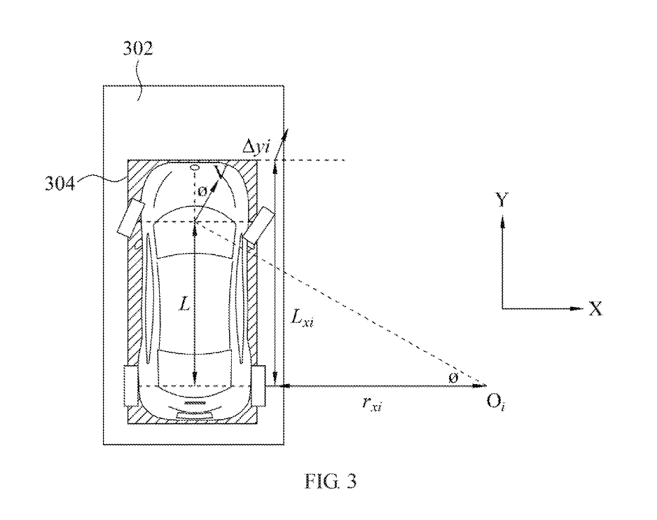

Time-delayed image data may be identified based on vehicle data. The vehicle data may be provided by control and/or monitoring systems (e.g., over a communications path such as a controller area network bus). FIG. 3 is an illustrative diagram showing how a future vehicle position may be calculated based on current vehicle data including steering angle φ (e.g., average front wheel angle), vehicle speed V, and wheelbase length L (i.e., length between front and rear wheels). The future vehicle position may be used to identify which portion of currently captured image data should be used to approximate blocked regions of the surrounding environment at a future time.

The angular speed of the vehicle may be calculated based on the current vehicle speed V, wheelbase length L, and steering angle φ (e.g., as described in equation 3).

$$ω = \frac{V}{L} csc ( Φ ) \qquad Equation 3$$

For each location, a corresponding future position may be calculated based on projected movement Δyi. Projected movement Δyi may be calculated based on that location's X-axis distance rxi and Y-axis distance Lxi from the center of the vehicle's turning radius and the vehicle angular speed (e.g., according to equation 4). For each location within camera-obstructed region 304, the projected movement can be used to determine whether the projected future location is within the currently viewable region of the vehicle's surroundings (e.g., region 302). If the projected location is located within the currently viewable region, then current image data for the projected location can be displayed to approximate the projected region of the future environment after the vehicle moves and the projected region of the environment becomes obstructed. Equation 4:

Δyᵢ=\sqrt{Lₓᵢ²+rₓᵢ²}×ω

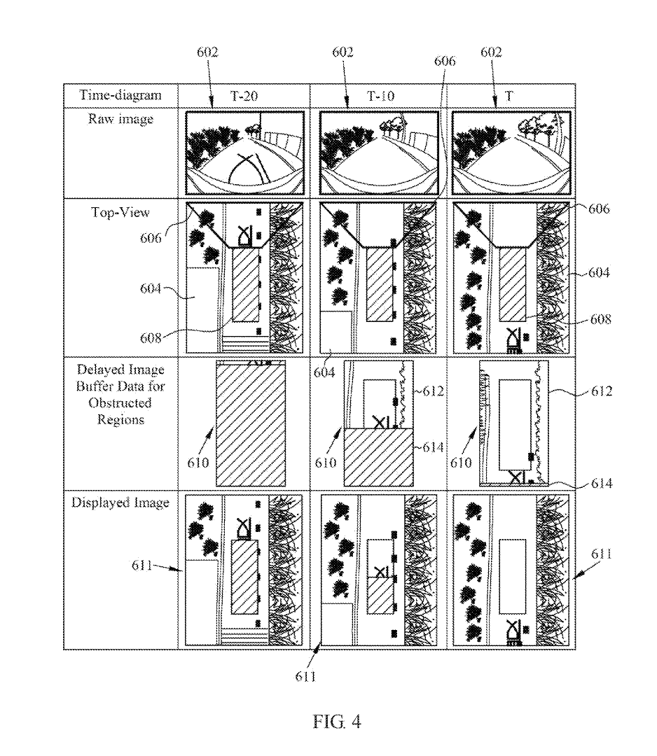

FIG. 4 is a diagram showing how raw camera image data may be coordinate-transformed and combined with time-delayed image data to display vehicle surroundings.

At initial time T-20, multiple cameras may capture and provide raw image data of the vehicle's surroundings. Raw image data frame 602 may be captured, for example, by a first camera mounted to the front of the vehicle, whereas additional raw image data frames may be captured by cameras mounted to the left side, right side, and rear of the vehicle (omitted from FIG. 4 for clarity). Each raw image data frame includes image pixels arranged in horizontal rows and vertical columns.

The imaging system may process the raw image data frame from each camera to coordinate-transform the image data to a common perspective. In the example of FIG. 4, image data frames from each of the front, left, right, and rear cameras may be coordinate-transformed from the perspective of that camera to a common birds-eye, top-view perspective (e.g., as described in connection with FIG. 2). The coordinate-transformed image data from the cameras may be combined to forma current live-view image 604 of the vehicle's surroundings. For example, region 606 may correspond to the surrounding area that is viewed and captured in raw image 602 from the front camera, whereas other regions of combined image 604 may be captured by other cameras. Top-view image 604 may be stored in an image buffer. If desired, additional image processing may be performed such as lens distortion processing that corrects for image distortion from focusing lenses of the cameras.

In some scenarios, the perspectives of cameras mounted to the vehicle may overlap (e.g., the views of front and side cameras may overlap at the border of region 606). If desired, the imaging system may combine overlapping image data from different cameras, which may help to improve the image quality at the overlapping regions.

As shown in FIG. 4, region 608 may reflect an obstructed portion of the surrounding environment. Region 608 may, for example, correspond to a vehicle chassis or other parts of the vehicle that obstruct the underlying road from the view of the cameras. The obstructed region(s) may be determined based on the mounting position and the vehicle's physical attributes (e.g., the size and shape of the vehicle frame). The imaging system may maintain a portion of the image buffer or a separate image buffer corresponding to the obstructed region(s) using delayed image data. At initial time T-20, no image data may have yet been saved, and image buffer portion 610 may be empty or filled with initialization data. The imaging system may display the combination of current camera image data and the delayed image buffer data as a composite image 611.

At subsequent time T-10, the vehicle may have moved relative to time T-20. The cameras may capture a different image due to its new environmental location (e.g., raw image 602 at time T-10 may be different than raw image 602 at time T-20), and thus top-view image 604 reflects that the vehicle has moved since time T-20. Based on vehicle data such as vehicle speed, steering angle, and wheelbase length, the image processing system may determine that part of viewable area 606 at time T-20 is now obstructed by the vehicle chassis (e.g., due to movement of the vehicle between times T-20 and T-10). The image processing system may transfer the identified image data from the previously viewable area 606 to corresponding region 612 of image buffer 610. Displayed image 611 includes the transferred image data in region 612 as a time-delayed approximation of part of the vehicle's surroundings that are now obstructed from camera view.

At time T-10, portion 614 of the image buffer remains empty or filled with initialization data, because the vehicle has not moved sufficiently to allow approximation via portions of previously-viewable surroundings. At subsequent time T, the vehicle may have moved sufficiently such that substantially all of the obstructed surroundings can be approximated with time-delayed image data captured from previously-viewable surroundings.

In the example of FIG. 4, the vehicle moves forward between times T-20 and T and the delayed image buffer is updated with images captured by a front vehicle camera. This example is merely illustrative. The vehicle may move in any desired direction, and the time-delayed image buffer may be updated with image data captured by any appropriate camera that is mounted to the vehicle (e.g., front, rear, or side cameras). In general, all or part of the combined image from the cameras (e.g., top-view image 604) at any given time may be stored and displayed as time-delayed approximations of future vehicle surroundings.

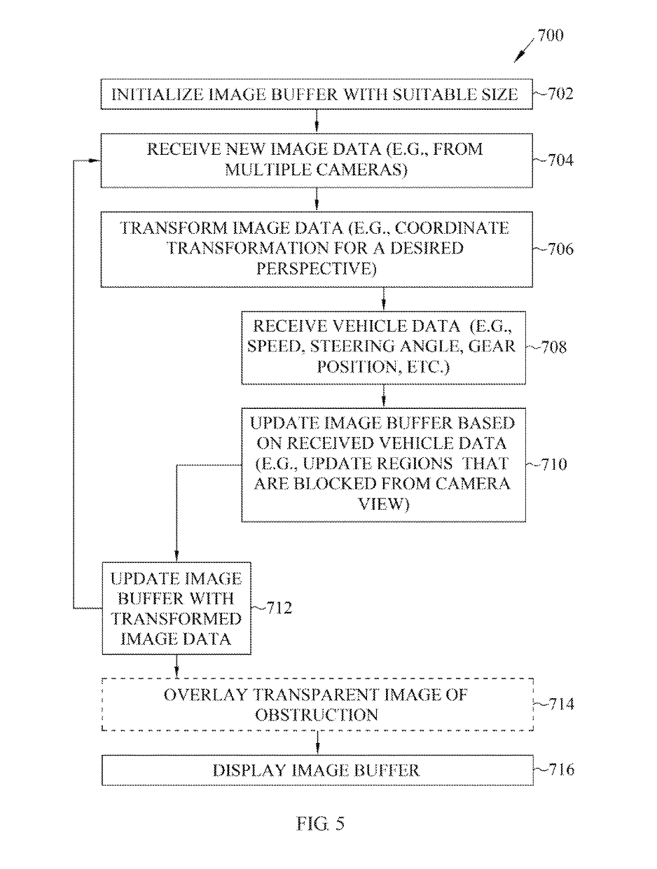

FIG. 5 is a flow chart of illustrative steps that may be performed by an image processing system in storing and displaying time-delayed image data in approximating current vehicle surroundings.

During step 702, the image processing system may initialize an image buffer with a suitable size for storing image data from vehicle cameras. For example, the system may determine the image buffer size based on a maximum vehicle speed that is desired or supported (e.g., a larger image buffer size for higher maximum vehicle speed, and a smaller size for a lower maximum vehicle speed).

During step 704, the image processing system may receive new image data. The image data may be received from one or more vehicle cameras, and may reflect the current vehicle environment.

During step 706, the image processing system may transform the image data from the camera's perspectives to a desired common perspective. For example, the coordinate transformation of FIG. 2 may be performed in projecting image data received from a particular camera to a desired coordinate plane for a desired view of the vehicle and its surroundings (e.g., a perspective view, a top-down view, or any other desired view).

During step 708, the image processing system may receive vehicle data such as vehicle speed, steering angle, gear position, and other vehicle data that can be used in identifying movement of the vehicle and corresponding shifts in image data.

During subsequent step 710, the image processing system may update the image buffer based on the received image data. For example, the image processing system may have allocated part of the image buffer such as region 608 of FIG. 4 to represent an obstructed region of the surrounding environment. In this scenario, the image processing system may process the vehicle data to determine which portions of previously captured image data (e.g., image data captured by cameras and received prior to the current iteration of step 704) should be transferred or copied to region 608. For example, the image processing system may process vehicle speed, steering angle, and wheelbase length to identify which image data from region 606 of FIG. 4 should be transferred to each portion of region 608. As another example, the image processing system may process gear information such as whether the vehicle is in a forward gear mode or a reverse gear mode to determine whether to transfer from image data received from a front camera (e.g., in region 606) or from a rear camera.

During subsequent step 712, the image processing system may update the image buffer with the new image data received from the cameras during step 704 and transformed during step 706. The transformed image data may be stored in regions of the image buffer that represent viewable portions of the surrounding environment (e.g., image buffer portion 604 of FIG. 4).

If desired, a transparent image of the obstruction may be overlaid with the image buffer during optional step 714. For example, as shown in FIG. 1, a transparent image of a vehicle may be overlaid with the portion of the image buffer that approximates the road underlying the vehicle (e.g., using time-delayed image data).

By combining currently captured image data during step 712 and previously captured (e.g., time-delayed) image data during step 710, the image processing system may produce and maintain a composite image in the image buffer that portrays the vehicle surroundings despite obstructions such as a vehicle chassis that block portions of the surrounding environment from view of the camera at any given time. The process may be repeated to create a video stream that displays the surrounding environment as if there were no obstructions to camera view.

During subsequent step 716, the image processing system may retrieve the composite image data from the image buffer and display the composite image. If desired, the composite image may be displayed with a transparent overlay of the obstruction, which may help to inform users of the obstruction's existence and that the information displayed within the overlay of the obstruction is time-delayed.

The example of FIG. 5 in which vehicle data is received during step 708 is merely illustrative. The operations of step 708 may be performed during any suitable time (e.g., before or after steps 704, 706, or 712).

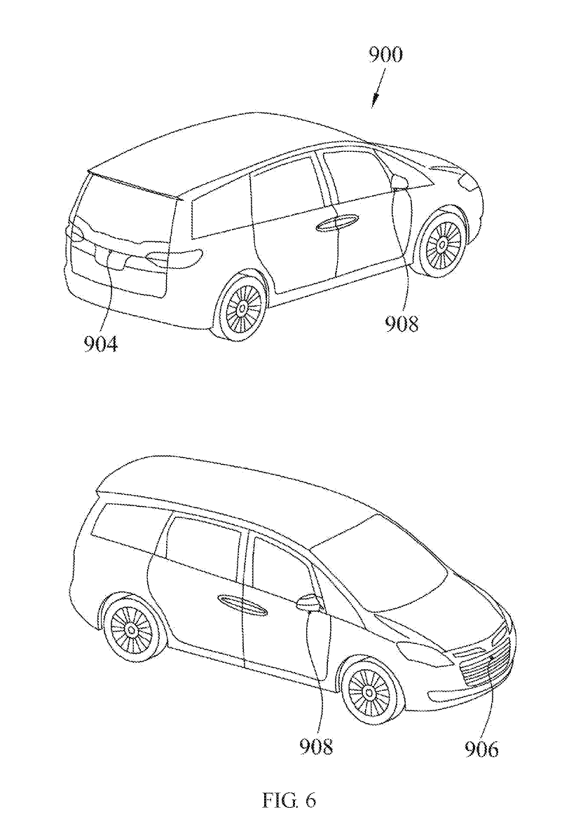

FIG. 6 shows illustrative views of a vehicle 900 and cameras that are mounted to the vehicle (e.g., to the vehicle frame or to other vehicle parts). As shown in FIG. 6, front camera 906 may be mounted to a front side (e.g., front surface) of the vehicle, whereas rear camera 904 may be mounted to an opposing rear side of the vehicle. Front camera 906 may be directed towards and capture images of the environment within the proximity of the front of vehicle 900, whereas rear camera 904 may be directed towards and capture images of the environment near the rear of the vehicle. Right camera 908 may be mounted to a right side of the vehicle (e.g., to a side-view mirror on the right side) and capture images of the environment on the right side of the vehicle. Similarly, a left camera may be mounted to a left side of the vehicle (omitted).

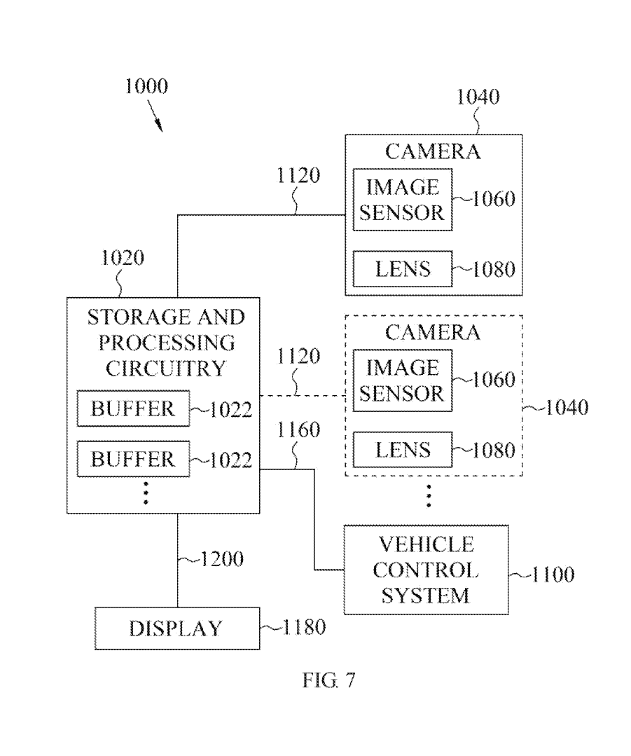

FIG. 7 shows an illustrative image processing system 1000 that includes storage and processing circuitry 1020 and one or more cameras 1040 (e.g., camera 1040 and one or more optional cameras 1040′). Each camera 1040 may include an image sensor 1060 that captures images and/or video. Image sensor 1060 may, for example, include photodiodes or other light-sensitive elements. Each camera 1040 may include a lens 1080 that receives and focuses light from the environment on a respective image sensor 1060. Image sensor 1060 may, for example, include horizontal and vertical rows of pixels that each captures light to produce image data. The image data from the pixels may be combined to form image data frames, and successive image data frames may form video data. The image data may be transferred to storage and processing circuitry 1020 over communications paths 1120 (e.g., cables or wires).

Storage and processing circuitry 1020 may include processing circuitry such as one or more general purpose processors, specialized processors such as digital signal processors (DSPs), or other digital processing circuitry. The processing circuitry may receive and process the image data received from cameras 1040. For example, the processing circuitry may perform the steps of FIG. 5 in generating composite obstruction-compensated images from current and time-delayed image data. The storage circuitry may be used in storing the image. For example, the processing circuitry may maintain one or more image buffers 1022 to store captured and processed image data. The processing circuitry may communicate with vehicle control system 1100 over communications path 1160 (e.g., one or more cables over which a communications bus such as a controller area network bus is implemented). The processing circuitry may request and receive vehicle data such as vehicle speed, steering angle, and other vehicle data from the vehicle control system over path 1160. Image data such as obstruction-compensated video may be provided to display 1180 for displaying (e.g., to a user such as a driver or passenger of the vehicle). For example, circuitry 1020 may include one or more display buffers (not shown) that provide display 1180 with display data. In this scenario, circuitry 1020 may transfer image data to be displayed from portions of image buffers 1022 to the display buffers during display operations.

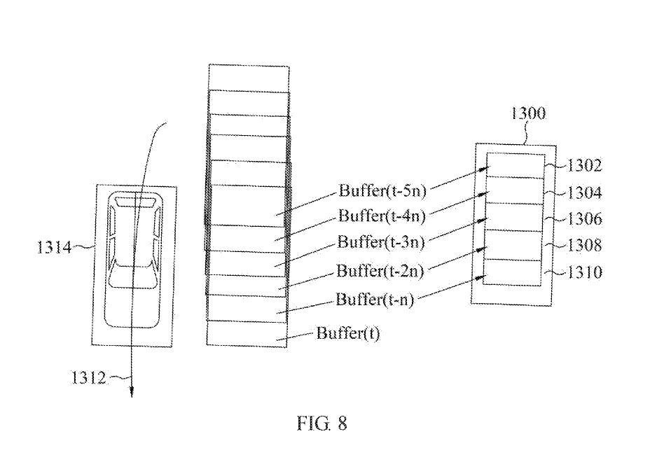

FIG. 8 is a diagram illustrating how multiple buffers may be updated in succession to store current and time-delayed camera image data in displaying an obstruction-compensated image of vehicle surroundings in accordance with an embodiment of the present invention. In the example of FIG. 8, image buffers are used to store successively captured image data at times t, t-n, t-2n, t-3n, t-4n, and t-5n (e.g., where n represents a unit of time that may be determined based on vehicle speeds to be supported by the imaging system).

In displaying an obstruction-compensated image of the vehicle surroundings, image data may be retrieved from the image buffers and combined, which may help to improve image quality by reducing blurriness. The number of buffers used may be determined based on vehicle speed (e.g., more buffers may be used for faster speeds, whereas fewer buffers may be used for slower speeds). In the example of FIG. 8, five buffers are used.

As the vehicle moves along a path 1312, the image buffers store successively captured images (e.g., combined and coordinate-transformed images from image sensors on the vehicle). At time t for currently vehicle location 1314, the obstructed portions of the current vehicle surroundings may be reconstructed by combining portions of images captured at time t-5n, t-4n, t-3n, t-2n, and t-n. The image data for obstructed vehicle surroundings may be transferred from portions of the multiple image buffers to corresponding portions of display buffer 1300 during display operations. Image data from buffer (t-5n) may be transferred to display buffer portion 1302, image data from buffer (t-4n) may be transferred to display buffer portion 1304, etc. The resulting combined image reconstructs and approximates the currently obstructed vehicle surroundings using time-delayed information previously stored at successive times in multiple image buffers.

The foregoing is merely illustrative of the principles of this invention and various modifications can be made by those skilled in the art without departing from the scope and spirit of the invention. The foregoing embodiments may be implemented individually or in any combination.

What is claimed is:

1. An automotive imaging system, comprising:
at least one image sensor that captures video images from a surrounding environment to produce successive image data frames, wherein portions of the surrounding environment are blocked from view of the at least one image sensor for any one of the image data frames; and
processing circuitry that receives the image data frames from the image sensor, wherein the processing circuitry processes the successive image data frames to generate image data portraying the blocked portions of the surrounding environment.

2. The automotive imaging system defined in claim 1 wherein a vehicle frame blocks the portions of the surrounding environment from the at least one image sensor and wherein the processing circuitry processes the successive image data frames to generate the image data for the blocked portions of the surrounding environment during movement of the vehicle.

3. The automotive imaging system defined in claim 2 wherein the processing circuitry receives vehicle data and generates the image data for the blocked portions of the surrounding environment based at least partially on the received vehicle data.

4. The automotive imaging system defined in claim 3 wherein the vehicle data comprises steering data that identifies a vehicle steering angle.

5. The automotive imaging system defined in claim 4 wherein the vehicle data further comprises vehicle speed data.

6. The automotive imaging system defined in claim 5 wherein the vehicle data identifies a current vehicle gear mode.

7. The automotive imaging system defined in claim 6 wherein the vehicle data further comprises a vehicle wheelbase length.

8. The automotive imaging system defined in claim 3 further comprising:
an image buffer, wherein the processing circuitry stores time-delayed image data from previous image data frames in the image buffer to portray the portions of the surrounding environment that are blocked from view by the vehicle frame.

9. The automotive imaging system defined in claim 8 wherein the image buffer comprises a first buffer portion and a second buffer portion, wherein the processing circuitry stores image data from a current image data frame in the first buffer portion, and wherein the processing circuitry stores the time-delayed image data from previous image data frames in the second buffer portion.

10. The automotive imaging system defined in claim 8 further comprising:
a display, wherein the processing circuitry displays a composite image from the first and second buffer portions using the display.

11. The automotive imaging system defined in claim 8 wherein the processing circuitry overlays a transparent image of the vehicle frame with the time-delayed image data.

12. The automotive imaging system defined in claim 3 wherein the at least one image sensor is mounted to an automotive vehicle, and wherein the processing circuitry identifies movement of the automotive vehicle based on the vehicle data and identifies the image data for the blocked portions of the surrounding environment from previously captured image data frames based on the identified movement of the automotive vehicle.

13. The automotive imaging system defined in claim 12 wherein the automotive vehicle has front, rear, left, and right surfaces, and wherein the at least one image sensor comprises a front image sensor mounted to the front surface of the automotive vehicle, a rear image sensor mounted to the rear surface of the automotive vehicle, a left image sensor mounted to the left surface of the automotive vehicle, and a right image sensor mounted to the right surface of the automotive vehicle.

14. A method of using an image processing system that processes images from at least one image sensor, wherein the at least one image sensor is mounted to a vehicle and captures images of vehicle surroundings, the method comprising:
with processing circuitry, receiving a first image data frame from the at least one image sensor at a first time;
with the processing circuitry, receiving a second image data frame from the at least one image sensor at a second time that is after the first time;
with the processing circuitry, identifying movement of the vehicle; and
with the processing circuitry, determining whether a portion of the first image data frame corresponds to a portion of the vehicle surroundings that is obstructed from view of the at least one image sensor at the second time.

15. The method defined in claim 14 further comprising:
with the processing circuitry, generating a composite image by combining the second image data frame with the identified portion of the first image data frame that corresponds to the obstructed portion of the vehicle surroundings; and
with a display, displaying the composite image as part of a video stream portraying the vehicle surroundings.

16. The method defined in claim 15 wherein generating the composite image comprises:
performing a coordinate transformation on the first image data frame from a first perspective to a second perspective.

17. The method defined in claim 16 wherein the at least one image sensor comprises a plurality of image sensors located at different positions around the vehicle, and wherein generating the composite image comprises:
combining additional image data frames from the plurality of image sensors with the second image data frame and the identified portion of the first image data frame that corresponds to the obstructed portion of the vehicle surroundings.

18. An automotive image processing system for a vehicle, the automotive image processing system comprising:
at least one camera mounted to the vehicle, wherein the at least one camera captures a video stream of vehicle surroundings; and
processing circuitry that receives the captured video stream from the at least one camera and modifies the captured video using time-delayed image data obtained from the captured video stream to portray obstructed portions of the vehicle surroundings.

19. The automotive image processing system defined in claim 18 wherein the vehicle has opposing front and rear sides and opposing left and right sides, and wherein the at least one camera comprises:
a front camera that captures video data for vehicle surroundings near the front side of the vehicle;
a rear camera that captures video data for vehicle surroundings near the rear side of the vehicle;
a left camera that captures video data for vehicle surroundings near the left side of the vehicle; and
a right camera that captures video data for vehicle surroundings near the right side of the vehicle.

20. The automotive image processing system defined in claim 19 further comprising:
a display that displays the modified video stream from the processing circuitry.

21. The automotive image processing system defined in claim 20 further comprising:
a plurality of image buffers, wherein the processing circuitry stores successive video frames from the captured video in the plurality of image buffers, and wherein the processing circuitry obtains the time-delayed image data by combining image data from the plurality of image buffers.
